(19) United States
(12) Patent Application Publication
(10) Pub. No.: US 2007/0008974 A1
(43) Pub. Date: Jan. 11, 2007

(54) Method, apparatus and computer program product for network services

(75) Inventors: Jean-Claude Dispensa, Saint Jeannet (FR); Eric Lebrun, Carros (FR)

Correspondence Address: ANTHONY ENGLAND, PO Box 5307, AUSTIN, TX, 78763-5307, US

(73) Assignee: International Business Machines Corporation, Armonk, NY (US)

(21) Appl. No.: 11/441,948

(22) Filed: May 25, 2006

(30) Foreign Application Priority Data
Jul. 7, 2005 (EP) 05106221.4

(51) Int. Cl. H04L 12/56

(52) U.S. Cl. 370/392; 370/401

(57) ABSTRACT

Network services are routed responsive to receiving a datagram. The datagram requests a certain network-delivered service and includes a virtual address for the service. An apparatus selects a physical address for a certain server from among a number of a physical addresses of respective servers associated by the apparatus with the virtual address. Performance of the respective servers is ranked so that the physical address are selected responsive to the performance ranks. The apparatus forwards the datagram, which includes the selected physical address for directing the datagram to the certain server.

### BACKGROUND

1. Field of the Invention

The present invention concerns providing network services, and, more particularly, concerns providing such network services in a way that disassociates from a network requester the physical addresses of devices that provide the services and that is responsive to performance of such service-providing devices.

2. Background Art

The Transmission Control Protocol/Internet Protocol (TCP/IP) suite (also referred to as “Internet protocol suite”) is a set of communication protocols for computer networking procedures of the Internet. TCP/IP is also widely used to facilitate communication within intranets. TCP/IP requires addresses and configuration settings to be defined on each host or peripheral connected to an intranet. For instance, to function correctly, the IP protocol of TCP/IP needs to know IP addresses of the source/recipient host, default router, etc.

Dynamic Host Configuration Protocol (DHCP) is a communication protocol that automates assignment of IP addresses for TCP/IP configurations. Workstations commonly use DHCP to automatically obtain such addresses and configurations. However, for application servers this is conventionally done manually, particularly for application servers connected to an intranet. That is, it is common to manually configure application servers connected to an intranet with the IP addresses of required IP services (e.g. Domain Name System [DNS], Network Time Protocol [NTP] and Simple Mail Transfer Protocol [SMTP]). One reason application servers are conventionally configured manually, rather than using DHCP, is that DHCP presents a security issue. A further problem with using DHCP on application servers is that DHCP does not retrieve NTP or SMTP server definitions.

Because the process of manually configuring application servers on a network can be time consuming, and because such a network may have numerous application servers, it can be a resource problem to maintain application servers on a network. This, in turn, can present an obstacle to providing high availability network services. For at least these reasons, a need exists to improve ways for accessing network services.

### SUMMARY OF THE INVENTION

The foregoing need is addressed in the present invention. According to one form of the invention, a method for accessing network services includes receiving a datagram by a router. The datagram requests a certain network-delivered service and includes a virtual address for the service. A router selects a physical address for a certain server from among a number of a physical addresses of respective servers associated by the router with the virtual address. Performance of the respective servers is ranked so that the physical IP address are selected responsive to the performance ranks. The router forwards the datagram, which includes the selected physical address for directing the datagram to the certain server.

In another aspect, the ranking of performance includes detecting levels of service for listed servers of the router. The detecting includes sending polling datagrams to the respective listed servers and measuring response times based upon responses received for the polling datagrams.

In another aspect, the polling datagrams poll applications running on the respective listed servers. The polling of such an application is at an application level, so as to ensure that the application is actually working.

In another aspect, the ranking of performance includes detecting, for listed servers of the router, availability of the listed servers. The detecting includes sending polling datagrams to the respective listed servers. Nonresponse indications are stored based upon lack of responses within a certain interval for the polling datagrams.

In another aspect, the ranking of performance includes computing products for the respective servers' predetermined weights and measured response times and ranking the servers according to these products. That is, a lowest product is ranked first and a highest product is ranked last.

In another aspect, the selecting of the physical network address for the certain server includes checking whether the virtual address of the received datagram matches a virtual address among pre-configured virtual addresses listed in an address translation table. The selecting also includes selecting a highest performance rank in the router's address translation table for the matching virtual address and selecting a certain physical network address in the address translation table. The certain physical network address is associated with the highest rank.

Variations, objects, advantages, and forms of the invention will become apparent upon reading the following detailed description and upon reference to the accompanying drawings.

### BRIEF DESCRIPTION OF THE DRAWINGS

The foregoing and other objects, aspects and advantages will be better understood from the following detailed description of a preferred embodiment(s) of the invention with reference to the drawings, in which:

FIG. 1 is a block diagram of network architecture for a network services access system, according to an embodiment of the present invention;

FIG. 2 is block diagram of a dynamic address translation table employed by a router of FIG. 1, according to an embodiment of the present invention;

FIG. 3 is a flow chart of a process performed by network address translation logic of the router shown in FIG. 1 responsive to receipt of a service request datagram from a customer server shown in FIG. 1, according to an embodiment of the present invention;

FIG. 4 is a flow chart of a process performed by performance logic of the router shown in FIG. 1 for updating the ranking of candidate IP service servers in the router's dynamic address translation table; according to an embodiment of the present invention; and

FIG. 5 is a block diagram of the dynamic address translation table of FIG. 1, according to an example scenario in an embodiment of the present invention.

FIG. 6 is a system suitable for a router server, such as shown in FIG. 1, according to an embodiment of the present invention.

### DETAILED DESCRIPTION OF THE PREFERRED EMBODIMENTS

In the following detailed description of the preferred embodiments, reference is made to the accompanying drawings illustrating embodiments in which the invention may be practiced. It should be understood that other embodiments may be utilized and changes may be made without departing from the scope of the present invention. The drawings and detailed description are not intended to limit the invention to the particular form disclosed. On the contrary, the intention is to cover all modifications, equivalents and alternatives falling within the spirit and scope of the present invention as defined by the appended claims. Headings herein are not intended to limit the subject matter in any way.

General Overview

One embodiment of the present invention includes a network services access system. The following description provides an broad overview of the network services access system, followed by a more detailed discussion of the hardware architecture of the system and operations performed therein.

According to the network services access system, intranet hosts collaborate with a router. The intranet hosts, which are typically servers deployed in a data center, are pre-configured with virtual IP addresses, and the router includes a dynamic address translation table that provides an adaptable reservoir of available IP services. The router includes dynamic network address translation (NAT) logic for mapping the virtual address of an IP service into a physical IP address.

More specifically, the intranet hosts (also known as “customer servers”) are preconfigured with virtual server IP addresses for respective IP services that they access, e.g. a virtual DNS server IP address, a virtual NTP server IP address, a virtual SMTP server IP address, etc. In practice, an intranet for an entire enterprise can use a single set of virtual servers to represent the IP services required enterprise-wide. Alternatively, the enterprise may use multiple sets of virtual servers, such as, for example, to isolate different organizations within the enterprise.

The virtual server addresses are independent of the physical addresses of the actual servers hosting the corresponding IP services, so that the virtual addresses need not change merely due to physical changes. Thus, physical addresses of devices that provide network services (servers) are disassociated from a network service requester. In one sense, the physical addresses of servers are disassociated from the network, more generally because the arrangement of the present invention permits IP service servers to be added, removed or displaced from a network without impacting the configuration of the customer servers. As a result, an IP service can be deployed locally in the same intranet as the customer servers, or remotely in another intranet, extranet, or the Internet.

The dynamic address translation table associated with the router links the virtual IP address of an IP service request from a customer server to a physical IP address of an IP service server best suited to provide the required service.

Hardware Architecture

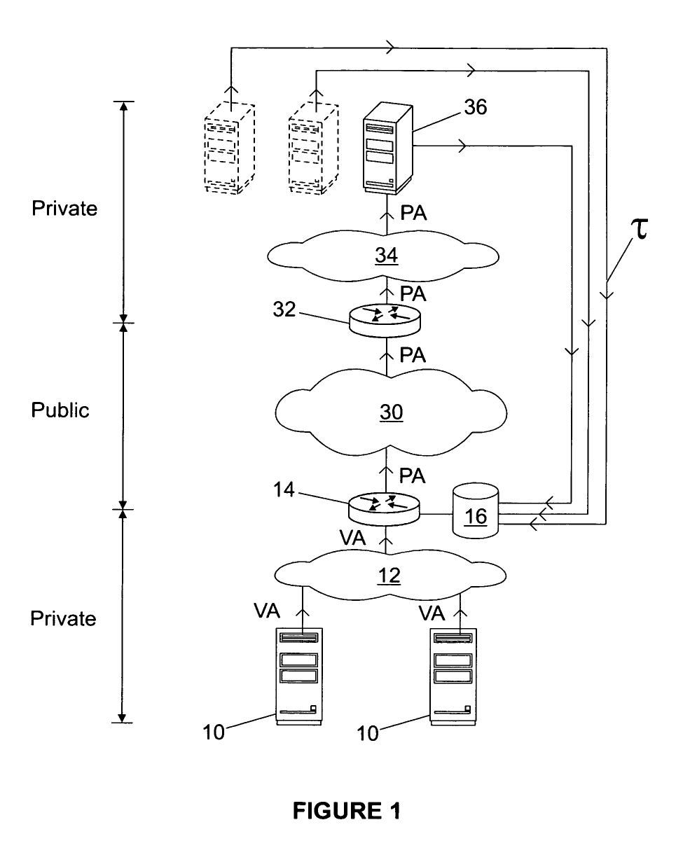

Referring now to FIG. 1, a network architecture is illustrated for the network services access system, according to an embodiment of the present invention. (It should be understood that the network services access system can be employed within a wide range of network architectures and is not limited to the specific network architecture described in the present example.) Network 5 includes customer servers 10, connected to a first intranet 12. As previously described, customer servers 10 are pre-configured with a virtual server IP addresses for each IP service they may access. Router 14, also connected to first intranet 12, includes a dynamic address translation table 16.

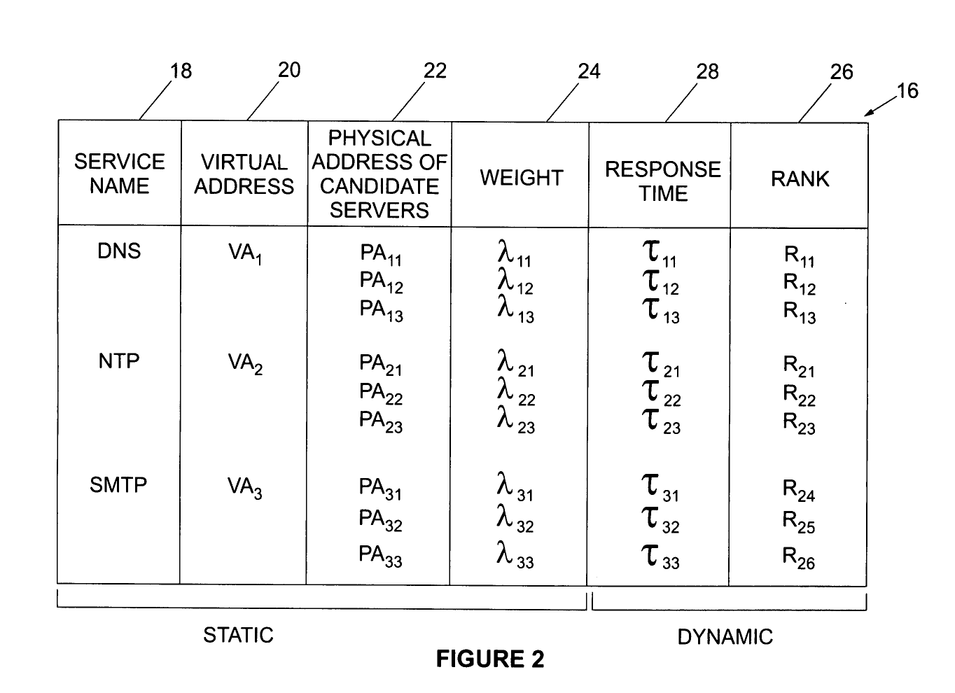

FIG. 2 illustrates dynamic address translation table 16, according to an embodiment of the invention. Dynamic address translation table 16 includes a list of IP services 18 required by customer servers 10. Dynamic address translation table 16 also includes virtual server IP addresses 20 for the IP services 18, wherein virtual addresses 20 correspond to those with which customer servers 10 have been pre-configured. Dynamic address translation table 16 also includes a list of physical IP addresses 22 of a number of possible physical network service servers for each IP service 18 and a weight 24 for each such physical network service server.

For example, FIG. 2 shows that in the illustrated embodiment of the invention there are three physical IP service servers 22 also referred to herein as “candidate IP service servers”) that are capable of supplying DNS service 18. The three candidate IP service servers 22 have physical IP addresses PA₁₁, PA₁₂ and PA₁₃. Customer servers 10 are pre-configured with a virtual server IP address 20 for this DNS service, which is address VA₁ in the illustrated instance. The dynamic address translation table also contains weights 24 for the three candidate IP service servers 22, which in the illustrated instance are weights λ₁₁, λ₁₂ and λ₁₃.

The listing of the required IP services 18, virtual addresses 20, physical addresses of candidate IP service servers 22 and weights 24 are static. However, the dynamic address translation table 16 also contains dynamically adaptable information, namely ranks 26 and response times 28 of candidate IP service servers 22.

In particular, candidate IP service servers 22 are accorded a rank 26 depending on their response time 28, weight 24 and availability. The ranks 26 are used to determine the IP service server best suited to respond to an IP service request. The ranks 26 are updated when router 14 periodically rechecks availability and response time of IP service servers 22.

For example, the candidate IP service servers 22, which are PA₁₁, PA₁₂, PA₁₃ in the present example of a DNS service request, have weights 24, which are λ₁₁, λ₁₂ and λ₁₃, respectively, and response times 28, which are τ₁₁, τ₁₂ and τ₁₃, respectively. Performance logic of a router 14 (FIG. 1) assigns ranks 26, which are R₁₁, R₁₂ and R₁₃ in the present example, where R₁₁ is greater than or equal to 1, R₁₂ and R₁₃ are each less than or equal to 3, to the three candidate IP service servers 22 responsive to the weights 24 and response times 28. The candidate server 22 with rank of “1” is considered to be the most suitable IP service server 22 to respond to the DNS service request.

Referring again to FIG. 1, router 14, which includes dynamic address translation table 16, is also connected to a public network 30 (e.g. a Wide Area Network backbone or the Internet). Public network 30 is connected through a second router 32 to a second intranet 34. Second intranet 34 includes at least one IP service server 36.

In use, a customer server 10 transmits an IP service request datagram to router 14 in order to request a particular service. The destination address of the IP service request datagram is one of the virtual addresses with which the customer server 10 has been pre-configured. The particularly requested service is indicated by the (virtual) destination address of the IP service request datagram. NAT logic of router 14 selects the physical IP address of the IP service server having the highest ranked performance for the particularly requested service. Router 14 then forwards the resulting IP datagram through public network 30, second router 32 and second intranet 34 to IP service server 36 having the selected the physical IP address.

Virtual Address Translation

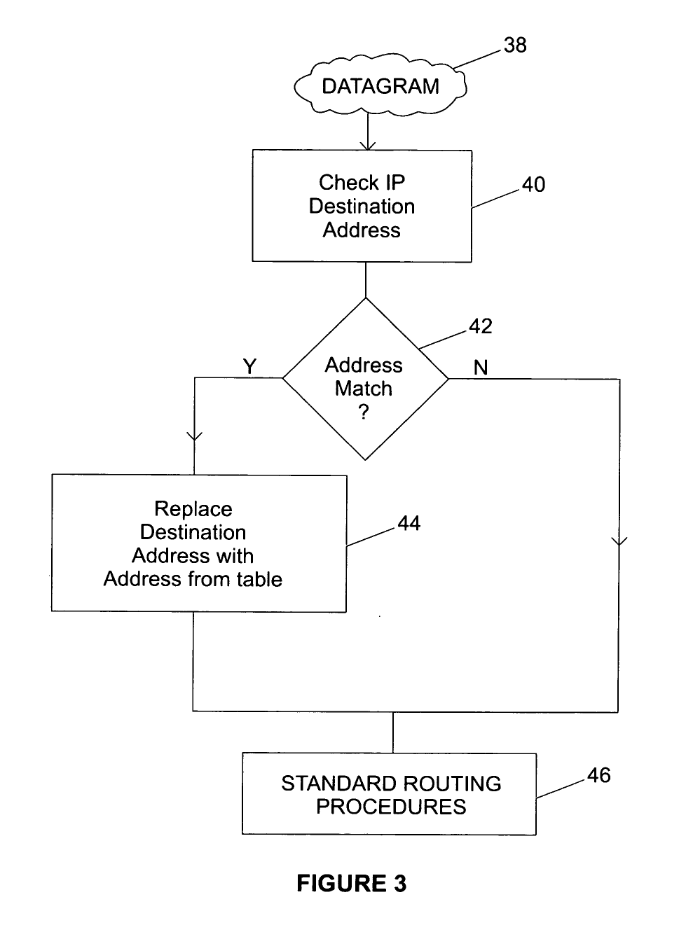

Referring to FIG. 3, NAT logic is illustrated, according to an embodiment of the present invention. For a router 14 (FIG. 1) that is proximate a customer server 10 (FIG. 1), NAT logic responds to receipt of an IP service request datagram 38 from the customer server 10 by checking 40 whether the destination address of datagram 38 matches one of the pre-configured virtual addresses listed in the router's dynamic address translation table 16 (FIGS. I and 2). In the event of a match 42, the NAT logic replaces 44 the destination address of the datagram with the physical IP address of the IP service server 36 (FIG. 1) best suited to supplying the required IP service (i.e. the IP service server with rank “1” in the router's dynamic address translation table). The router then forwards the amended IP service request datagram to the relevant IP service server by means of standard routing procedures 46 using the amended datagram's new destination IP address.

The above described NAT logic also is operable in reverse, namely when returning an IP datagram from an IP service server in response to an IP service request from a customer server. In particular, on receipt of an IP service datagram from an IP service server, NAT logic of the router converts the datagram's source IP address (i.e. of the IP service server) into the appropriate virtual IP address used by the customer servers.

Updating Ranking of Candidate IP Service Servers

According to an embodiment of the invention, from time to time (e.g., at periods known as the trigger period (T_{trig})), performance logic of a router monitors each of the IP service servers listed in its dynamic address translation table to ensure and maintain quality of service (QoS). In particular, the router monitors the IP services servers for a fixed time interval known as the monitoring interval (Tₘₒₙ) wherein Tₘₒₙ<T_{trig}. This monitoring not only detects availability of the servers hosting the relevant IP services, but also detects levels of performance of respective IP services.

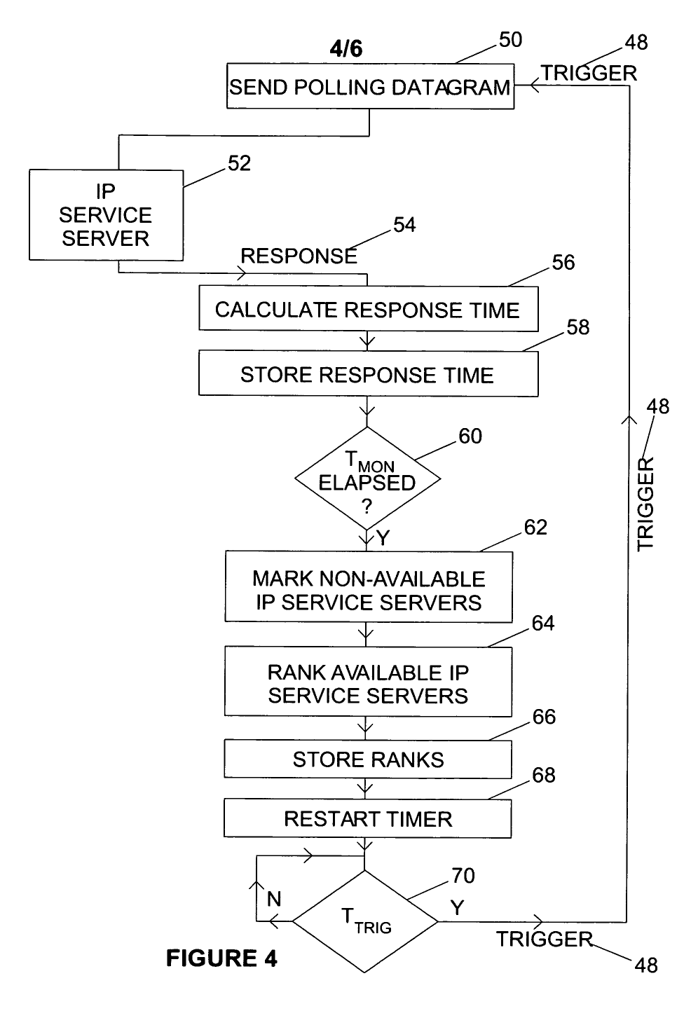

Referring to FIG. 4, performance logic is illustrated, according to an embodiment of the present invention. On receipt of a trigger 48 from an internal timing system, router performance logic sends 50 a polling datagram to each of the IP service servers 52 listed in its dynamic address translation table. It should be noted that the polling operations are performed at the application level, e.g., DNS query or NTP time retrieval, so as to be sure that the required application is really working in the IP services server. Simple polling at the IP address level is not sufficient for the present method, since this form of polling could work even though a required application is stuck.

On receipt of the polling datagram, each IP service server 52 returns a response 54 to the router. On receipt of a response 54, the router's performance logic calculates 56 the response time of the relevant IP service server and stores 58 the response time in its dynamic address translation table.

When the monitoring interval Tₘₒₙ has elapsed 60, the router's performance logic marks 62 any IP service servers that did not respond to the polling datagram as being non-available. The performance logic ranks the remaining IP service servers according to their weights (stored in the router's dynamic address translation table) and the servers' response times. In particular, performance logic ranks the remaining IP service servers so that the server with the smallest weight and smallest response time attains the highest rank.

More specifically, according to an embodiment of the present invention, the performance logic computes products for the respective servers' predetermined weights 124 and measured response times 128, and ranks the servers according to these products, with the lowest product ranked first (i.e., highest rank) and the highest product ranked last. According to one embodiment of the present invention, in the case of ties servers having smaller weights are ranked higher than servers having associated larger weights. In another variation, in the case of ties servers having larger weights are ranked higher than servers having associated smaller weights. In still another variation, in the case of ties servers are assigned the same rank.

Then the performance logic stores the ranks of the IP service servers in the router's dynamic address translation table and restarts its internal timer. The internal timer issues another trigger to restart the performance logic's monitoring operations after the trigger period (T_{trig}) has elapsed.

### Example Scenario

Let A₁ and A₂ be two customer servers configured with:

(a) a DNS virtual address of 10.1.1.1;

(b) a NTP virtual address of 10.2.2.2; and

(c) a SMTP server address of 10.3.3.3.

In this case, all DNS query datagrams sent by A₁ or A₂ will have 10.1.1.1 as their destination address.

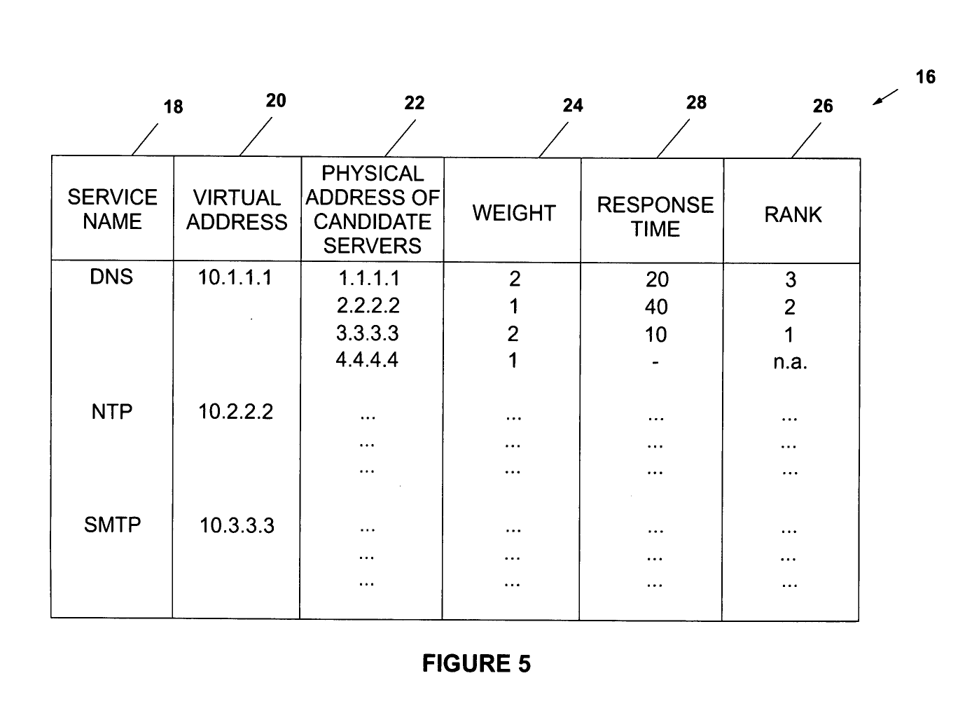

Referring to FIG. 5, in the illustrated scenario dynamic address translation table 16 of a router 14 (FIG. 1) is configured with the above virtual addresses 20 and physical IP addresses 22 of four candidate DNS servers, which in the illustrated scenario are physical IP addresses 1.1.1.1, 2.2.2.2, 3.3.3.3, 4.4.4.4. Dynamic address translation table 16 is also configured with weights 24 for the candidate DNS servers, which in the illustrated scenario are weights of 2, 1, 2, and 1, respectively.

Router 14 performance logic determines the response times 28 of the candidate DNS servers and stores the response times 28 in dynamic address translation table 16, which in the illustrated instances are as follows:

response time of 20 millisecond for the server 22 at 1.1.1.1;

response time of 40 millisecond for the server 22 at 2.2.2.2;

response time of 10 millisecond for the server 22 at 3.3.3.3; and

no response for the server 22 at 4.4.4.4.

The performance logic determines a rank for each candidate DNS server based on its weight 24 and the measured response time 28. The performance logic also stores the ranks 26 of the candidate DNS servers in dynamic address translation table 16. In the present example, candidate DNS server at IP address 3.3.3.3 is ranked first because of its weight 24 times its response time 28 yields a product of 20, which is lower than either of the other two products. In the variation illustrated, servers having smaller weights are ranked higher than servers having associated larger weights in the case of ties. Thus, although the products of weights 24 and response times 28 for the server 22 at address 2.2.2.2 is ranked higher than the server 22 at address 1.1.1.1. It will be appreciated that the ranks of candidate DNS servers 22 may vary from one monitoring period to the next, depending on availability and response times 28.

On receipt of a DNS request datagram from customer server A₁ or A₂ (i.e. datagram with virtual destination address 10.1.1.1), router 14 NAT logic translates the virtual address (10.1.1.1) into the physical IP address (3.3.3.3) of the currently highest ranked candidate DNS server. NAT logic does this by looking up the highest rank for the servers 22 associated with a “10.1.1.1” virtual destination address 20 in table 16 and then looking up the physical address 22 associated with that rank 26. Conversely, on receipt of a DNS response datagram from the highest ranked candidate DNS server, router 14 NAT logic translates its “3.3.3.3” physical IP address 22 into the “10.1.1.1” virtual DNS address 20. NAT logic does this by looking up “3.3.3.3” in the column of physical IP addresses 22, which may be a content addressable memory, and then looking across the table 16 to the “10.1.1.1” virtual destination address 20 associated with that “3.3.3.3” physical IP address 22.

Router, Server and Computer System

It should be understood that the use of the terms “router” and “server” are not intended to limit the router or server of the present invention to a particular form. A router according to the present invention may take the form of a computer system. Likewise, a server according to the present invention may take the form of a computer system. It should be understood that the term “computer system” is intended to encompass any device having a processor that executes instructions from a memory medium, regardless of whether referred to in terms of a microcontroller, personal computer system, mainframe computer system, workstation, server, or in some other terminology.

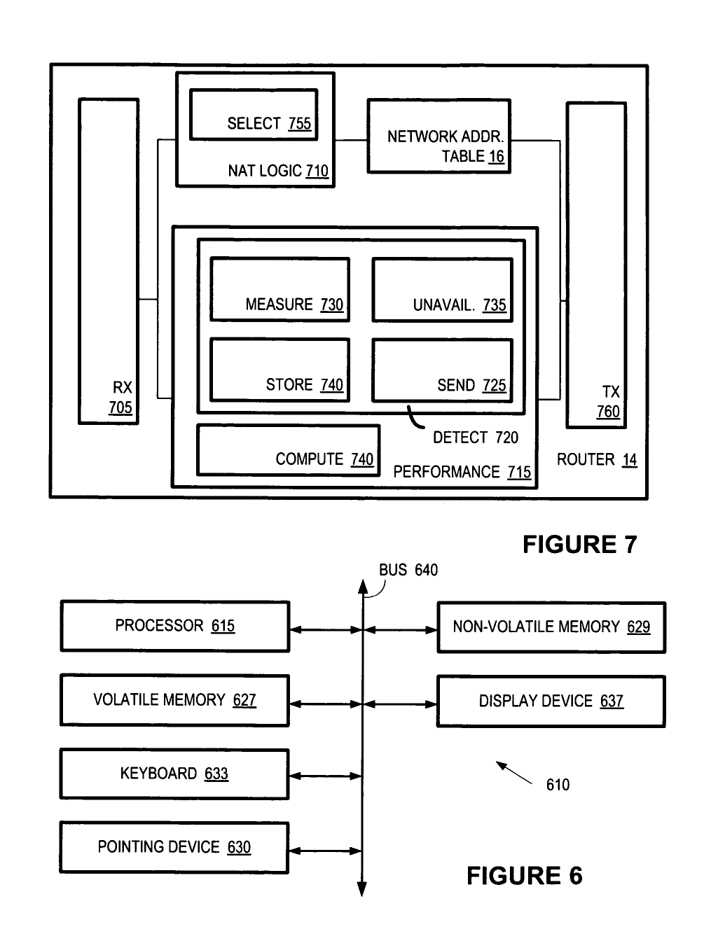

Referring now to FIG. 6, a system 600 suitable for a router or server, such as router 14 or server 10 of FIG. 1, are illustrated, according to an embodiment of the present invention. System 600 takes the form of a computer system._Computer system 600 includes one or more processors 615, a volatile memory 627, e.g., RAM and a nonvolatile memory 629. Memories 627 and 629 store program instructions (also known as a “software program”), which are executable by processor(s) 615, to implement various embodiments of a software program in accordance with the present invention. Processor(s) 615 and memories 627 and 629 are interconnected by bus 640. An input/output adapter (not shown) is also connected to bus 640 to enable information exchange between processor(s) 615 and other devices or circuitry. System 600 may include a keyboard 633, pointing device 630, e.g., mouse, floppy disk, CD-ROM, and DVD, and a display device 637.

Referring now to FIG. 7, a block diagram of logic circuitry for a router 14 is illustrated, according to an embodiment of the invention. Router 14 includes receiver circuitry 705 for connecting router 14 to a network and receiving a datagram therefrom. The datagram requests a certain network-delivered service and includes a virtual address for the service. Router 14 also has network address translation logic 710 for selecting a physical address for a certain server from among a number of a physical addresses of respective servers associated by the apparatus with a virtual address.

Performance logic of router 14 is operable to rank performance of the respective servers, as described herein above. Network address translation logic 710 selects the physical IP address responsive to the performance ranks and inserts the selected physical address in the datagram for directing the datagram to the certain server.

Performance logic 715 also includes detecting logic 720 for detecting levels of service for listed servers of the router. Detecting logic 720 includes sending logic 725 for sending polling datagrams to the respective listed servers and response time measuring logic 730 for measuring response times based upon responses received for the polling datagrams. The polling datagrams poll applications running on the respective listed servers. The polling of such an application is at an application level, so as to ensure that the application is actually working.

In another aspect of detecting logic 720, for listed servers of router 14 detecting logic 720 includes availability detecting logic 735 for detecting availability of the listed servers based upon lack of responses within a certain interval for the polling datagrams.

Detecting logic 720 includes storing logic 740 for storing nonresponse indications based upon such a lack of response, as determined by availability detecting logic 735 and for storing response times measured by response time measuring logic 730.

Performance logic 715 also has computing logic 745 for computing products for the respective servers' predetermined weights and measured response times. Performance logic 715 also ranking logic for ranking the servers according to these products, wherein a lowest product is ranked first and a highest product is ranked last.

Network address translation logic 710 includes match checking logic 750 for checking whether the virtual address of the received datagram matches a virtual address among preconfigured virtual addresses listed in address translation table 16 of router 14. Network address translation logic 710 also includes selecting logic 755 for selecting a highest performance rank in the router's address translation table for the matching virtual address responsive to the performance ranks and selecting a certain physical network address in the address translation table, i.e., the physical network address that is associated with the highest rank. Selecting logic 755 communicates the selected physical address to transmitting logic 760 for inserting in the datagram. Thus, the forwarded datagram includes the selected physical address for directing the datagram to the certain server.

General Remarks and Variations

The present invention provides a mechanism for centrally changing network configurations, such as Internet Protocol configurations, without necessitating manual reconfiguring of each application server on a network. In particular, each IP service is designated with a predefined virtual address and each application server is preconfigured with these virtual addresses. A virtual address is static and the process of mapping a virtual address to a physical IP address is facilitated by the ranked list of candidate IP service servers for the requested IP service. In essence, this mechanism makes it easier to add, delete or displace an IP service server from a network since it is no longer necessary to independently reconfigure each application server on the network.

While the invention has been particularly shown and described with reference to a preferred embodiment, it will be understood that various changes in form and detail may be made therein without departing from the spirit, and scope of the invention.

Moreover, the processes of the present invention are capable of being distributed in the form of a computer readable medium of instructions. Such computer readable medium may have a variety of forms. The present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

Various embodiments implement the one or more software programs in various ways, including procedure-based techniques, component-based techniques, and/or object-oriented techniques, among others. Specific examples include XML, C, C++ objects, Java and commercial class libraries. Those of ordinary skill in the art will appreciate that the hardware depicted herein may vary depending on the implementation. For example, other peripheral devices may be used in addition to or in place of the hardware depicted in FIG. 3. The depicted example is not meant to imply architectural limitations with respect to the present invention.

The terms “logic” or “memory” are used herein. It should be understood that these terms refer to circuitry that is part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

To reiterate, one or more embodiments were chosen and described in order to best explain the principles of the invention and its practical application, and to enable others of ordinary skill in the art to understand the invention. Various other embodiments having various modifications may be suited to a particular use contemplated, but may be within the scope of the present invention.

Herein above, and in the following claims, the term “comprises” is synonymous with “includes.” The use of terminology such as “X comprises A, B and C” is not intended to imply that A, B and C are necessarily all of the components of X, unless this is clearly and explicitly stated. Likewise, the terms “including,” “carrying,” “having,” “containing,” “involving,” and the like are to be understood to be open-ended, that is, to mean including but not limited to. Only the transitional phrases “consisting of” and “consisting essentially of,” respectively, shall be closed or semi-closed transitional phrases, as set forth, with respect to claims, in the United States Patent Office Manual of Patent Examining Procedures (Eighth Edition, August 2001 as revised May 2004), Section 2111.03.

The claims that follow are not intended to imply any particular sequence of actions, unless this is clearly and explicitly stated. The inclusion of labels, such as a), b), c), etc., for portions of the claims does not, by itself, imply any particular sequence, but rather is merely to facilitate reference to the portions. Likewise, use of ordinal terms such as “first”, “second,” “third,” etc., in the claims to modify a claim element does not by itself connote any priority, precedence, or order of one claim element over another or the temporal order in which acts of a method are performed. Such ordinal terms may be used merely as labels to distinguish one claim element having a certain name from another element having a same name (but for use of the ordinal term). Of course, ordinal terms in the context of ranking do indicate order.

What is claimed is:

1. A method of providing network services comprising the steps of:
receiving a datagram by a router, wherein the datagram requests a certain network-delivered service and includes a virtual address for the service;
ranking performance of respective servers;
selecting a physical address for one of the respective servers from among a number of physical addresses of the respective servers associated by the router with the virtual address, wherein the selecting of the physical address is responsive to the performance rankings of the respective servers; and
forwarding the datagram, wherein the forwarded datagram includes the selected physical address for directing the datagram to the one server.

2. The method of claim 1, wherein the ranking of performance includes detecting levels of service for listed servers of the router and the detecting includes:
sending polling datagrams to the respective listed servers; and
measuring response times based upon responses received for the polling datagrams.

3. The method of claim 2, wherein the sending step includes the polling datagrams polling, at an application level, applications running on the respective listed servers, to check whether the application is actually working.

4. The method of claim 1, wherein the ranking of performance includes detecting, for listed servers of the router, availability of the listed servers, wherein the detecting includes:
sending polling datagrams to the respective listed servers; and storing nonresponse indications based upon lack of responses within a certain interval for the polling datagrams.

5. The method of claim 2, wherein the ranking of performance includes computing products for the respective servers' predetermined weights and measured response times, and ranking the servers according to these products, wherein a lowest product is ranked first and a highest product is ranked last.

6. The method of claim 1, wherein the selecting of the physical network address for one of the respective servers includes:
checking whether the virtual address of the received datagram matches a virtual address among pre-configured virtual addresses listed in an address translation table; and
selecting a highest performance rank in the router's address translation table for the matching virtual address and selecting a certain physical network address in the address translation table, wherein the certain physical network address is associated with the highest rank.

7. A computer program product for an apparatus providing network services, wherein the computer program product resides on a computer readable medium having computer readable program code and the program code comprises:
instructions for receiving a datagram, wherein the datagram requests a certain network-delivered service and includes a virtual address for the service;
instructions for ranking performance of respective servers;
instructions for selecting a physical address for one of the respective servers from among a number of physical addresses of the respective servers associated with the virtual address, wherein the selecting of the physical address is responsive to the performance rankings of the respective servers; and
instructions for forwarding the datagram, wherein the forwarded datagram includes the selected physical address for directing the datagram to the one server.

8. The computer program product of claim 7, wherein the instructions for ranking of performance include instructions for detecting levels of service for listed servers of the apparatus, wherein the instructions for detecting levels of service include:
instructions for sending polling datagrams to the respective listed servers; and
instructions for measuring response times based upon responses received for the polling datagrams.

9. The computer program product of claim 8, wherein the instructions for sending polling datagrams include instructions for the polling datagrams polling, at an application level, applications running on the respective listed servers, to check whether the application is actually working.

10. The computer program product of claim 7, wherein the instructions for ranking of performance include instructions for detecting, for listed servers of the apparatus, availability of the listed servers, wherein the instructions for detecting include:
instructions for sending polling datagrams to the respective listed servers; and storing nonresponse indications based upon lack of responses within a certain interval for the polling datagrams.

11. The computer program product of claim 7, wherein the instructions for ranking of performance include:
instructions for computing products for the respective servers' predetermined weights and measured response times; and
instructions for ranking the servers according to these products, wherein a lowest product is ranked first and a highest product is ranked last.

12. The computer program product of claim 7, wherein the instructions for selecting the physical network address for one of the respective servers include:
instructions for checking whether the virtual address of the received datagram matches a virtual address among pre-configured virtual addresses listed in an address translation table; and
instructions for selecting a highest performance rank in the apparatus's address translation table for the matching virtual address and selecting a certain physical network address in the address translation table, wherein the certain physical network address is associated with the highest rank.

13. A network services apparatus for providing network services comprising:
address translation logic for selecting a physical address for one of a plurality of respective servers from among physical addresses of the respective servers associated by the apparatus with a virtual address, wherein a datagram is received by the apparatus, the datagram requesting a certain network-delivered service and including the virtual address for the service; and
performance logic for ranking performance of the respective servers, wherein the address translation logic is operable to select the physical address responsive to the performance ranks and communicate the selected physical address for inserting in the datagram, so that the datagram is directed to the one server.

14. The apparatus of claim 13, wherein the performance logic includes detecting logic for detecting levels of service for listed servers associated with the network services apparatus, wherein the detecting logic includes:
logic for sending polling datagrams to the respective listed servers; and
logic for measuring response times based upon responses received for the polling datagrams.

15. The apparatus of claim 14, wherein the logic for sending polling datagrams to the respective listed servers includes polling datagrams polling, at an application level, applications running on the respective listed servers, to check whether the application is actually working.

16. The apparatus of claim 13, wherein the performance logic includes detecting logic, wherein for listed servers associated with the network services apparatus the detecting logic detects availability of the listed servers, wherein the detecting logic includes:
logic for sending polling datagrams to the respective listed servers; and
logic for storing nonresponse indications based upon lack of responses within a certain interval for the polling datagrams.

17. The apparatus of claim 14, wherein the performance logic includes:
computing logic for computing products for the respective servers' predetermined weights and measured response times; and
ranking logic for ranking the servers according to these products, wherein a lowest product is ranked first and a highest product is ranked last.

18. The apparatus of claim 13, wherein the address translation logic includes:
logic for checking whether the virtual address of the received datagram matches a virtual address among pre-configured virtual addresses listed in an address translation table; and
logic for selecting a highest performance rank in the network services apparatus's address translation table for the matching virtual address and selecting a certain physical network address in the address translation table, wherein the certain physical network address is associated with the highest rank.

19. A method of delivering network services, comprising the steps of:
receiving a datagram by a router, wherein the datagram requests a certain network-delivered service and includes a virtual address for the service;
ranking performance of respective servers, wherein the ranking includes detecting levels of service for listed servers of the router and the detecting includes:
sending polling datagrams to the respective listed servers;
measuring response times based upon responses received for the polling datagrams; and
detecting nonresponse indications based upon lack of responses within a certain interval for the polling datagrams, and wherein the method includes:
selecting a physical address for a one of the respective servers from among a number of a physical addresses of the respective servers associated by the router with the virtual address,
wherein the selecting of the physical network address for the certain server includes:
checking whether the virtual address of the received datagram matches a virtual address among pre-configured virtual addresses listed in an address translation table; and
selecting a highest performance rank in the router's address translation table for the matching virtual address and selecting a certain physical network address in the address translation table, wherein the certain physical network address is associated with the highest rank, and wherein the method includes:
forwarding the datagram, wherein the forwarded datagram includes the selected physical address for directing the datagram to the certain server.

20. The method of claim 19, wherein the ranking of performance includes computing products for the respective servers' predetermined weights and measured response times, and ranking the servers according to these products, wherein a lowest product is ranked first and a highest product is ranked last.
